(19) United States
(12) Patent Application Publication
(10) Pub. No.: US 2003/0215313 A1
(43) Pub. Date: Nov. 20, 2003

(54) Device for pivotably moving a two-wheel device

(76) Inventor: Gary L. Hinkle, Lyons, OH (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 10/145,062

(22) Filed: May 14, 2002

(51) Int. Cl. B62H 3/00; B60P 3/00

(52) U.S. Cl. 414/426; 414/401; 414/537; 104/44

(57) ABSTRACT

A carousel device for pivotally moving a two-wheeled vehicle includes a base with a plurality of roller bearings and a carousel having a pair of opposing wings which are operatively positioned on the base.

### FIELD OF THE INVENTION

The present invention relates to a device for pivotably moving a heavy object, and more particularly for moving the heavy object, such as, for example, a motorcycle, in a small or confined area.

### BACKGROUND OF THE INVENTION

Today's motorcycles are large, often weighing over one thousand pounds or more. While riders of these motorcycles can easily maneuver the motorcycles at operating speeds, it is difficult for the rider to move the motorcycle when the vehicle is stopped or in idle. The rider must have sufficient strength to move the vehicle when the vehicle is not running not in gear.

Often, owners of motorcycles wish to keep the motorcycle in a confined or small parking in a garage or other protected area. The motorcycle rider must move the motorcycle in and out of the confined space by continually repositioning or moving the motorcycle back and forth many times in order to position the motorcycle in a desired space. For example, if a vehicle is driven headfirst into a space, often the rider wishes to have the motorcycle facing outward again when removing the motorcycle from the space. This causes the rider to spend great amounts of effort and energy when maneuvering the motorcycle in a confined space. Alternatively, the motorcycle would have to be in a large enough space to turn the vehicle in a 180° radius. This also causes problems, however, because turning the motorcycle in a short radius or a moving forwards and backwards can sometimes be dangerous. Therefore, there is a need for a device for rotatably moving the motorcycle in an enclosed area.

There is also a need to be able to rotatably turn the motorcycle 180° so that the motorcycle can be positioned for a forward exit.

There is a further need to have a device which allows a motorcycle to be easily positioned thereon without having to lift or raise the motorcycle from the ground.

There is a further need for a device which allows the motorcycle to be parked with a kickstand on a ground surface.

### DETAIL DESCRIPTION OF THE INVENTION

According to one aspect of the present invention, there is provided a device for parking a motorcycle which includes a carousel and a pair of opposing wings extending from the carousel. The carousel has a plurality of roller bearings mounted on a lower surface to allow for easy maneuverability of the carousel device.

The pair of opposing wings is positioned at an opposing, or 180°, angle with respect to each other on the carousel. Each wing is mounted at a first end to a section of the carousel. Each wing has a second end which is an opposed relationship to the first end. The second end defines a downwardly extending angle which allows the motorcycle to be easily rolled onto the wing. The wings have sufficient length to accommodate various sizes and widths of motorcycles.

In a preferred aspect, the carousel has a plurality of, and in certain embodiments, at least about 10 to about 20, and in certain aspects of about 16 carousel roller bearings, preferably mounted at evenly spaced intervals thereon, to allow for smooth or gliding turning of the carousel device. The carousel device can be pivoted in a 360° radius.

In a preferred aspect, the carousel device has a low profile such that motorcycle rider hardly perceives that the motorcycle is leaving the ground. The carousel allows the rider to move the motorcycle onto the low profile carousel without the need for any “balancing” or feeling of tipping over. In certain embodiments, the carousel has an elevation of about 1½ to about 2 inches, and in certain embodiments, about 1⅝ inches from the ground to the top of the carousel device. The low profile of the carousel device readily allows the rider to easily move the motorcycle onto the carousel device.

In certain aspects of the present invention, at least one wing roller bearing can be positioned on a lower surface of each wing to further allow the carousel to rotatably turn. The wing roller bearing is capable of supporting the full weight of the motorcycle on the carousel device. The wing roller bearings allow the wing to pivot about an axis through the center of the carousel.

Other objects, features and advantages of the present invention will become apparent upon reading the following detailed description of the embodiments of the invention, when taken in conjunction with the accompanying drawings and claims.

### BRIEF DESCRIPTION OF THE DRAWINGS

FIG. 1 is a perspective view of a motorcycle on a carousel device of the present invention.

FIG. 2 is a top plan view of one wing showing bearings mounted in supports on a lower surface of the wing.

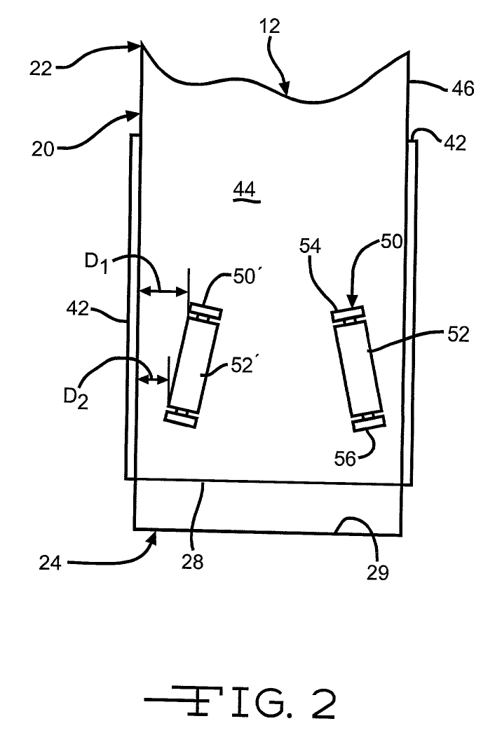

FIG. 3 is a perspective view of one end of one wing showing bearings mounted in supports on a lower surface of the wing.

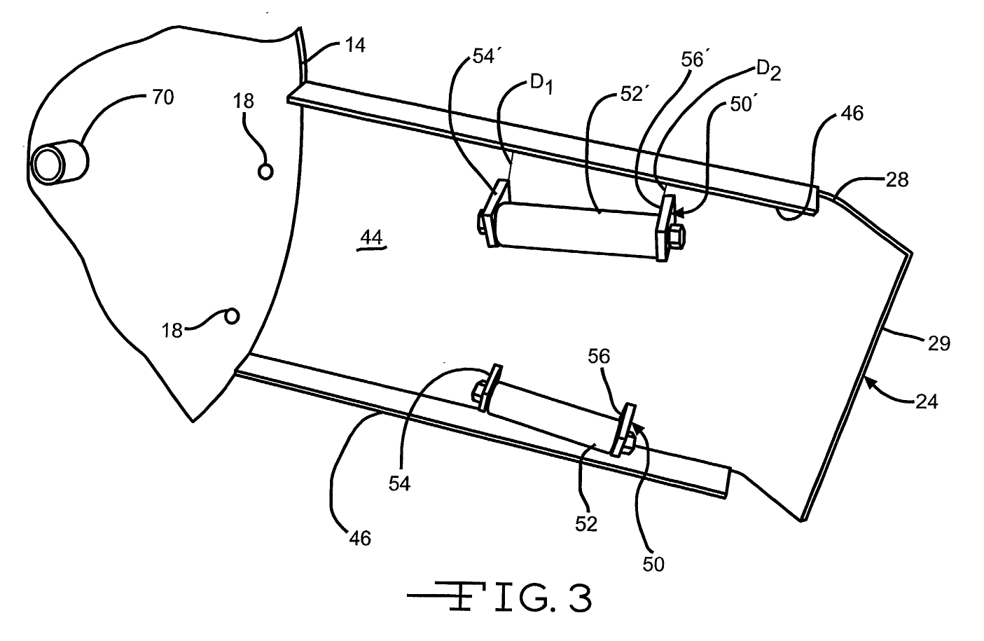

FIG. 4 is a perspective view of the base of the carousel device.

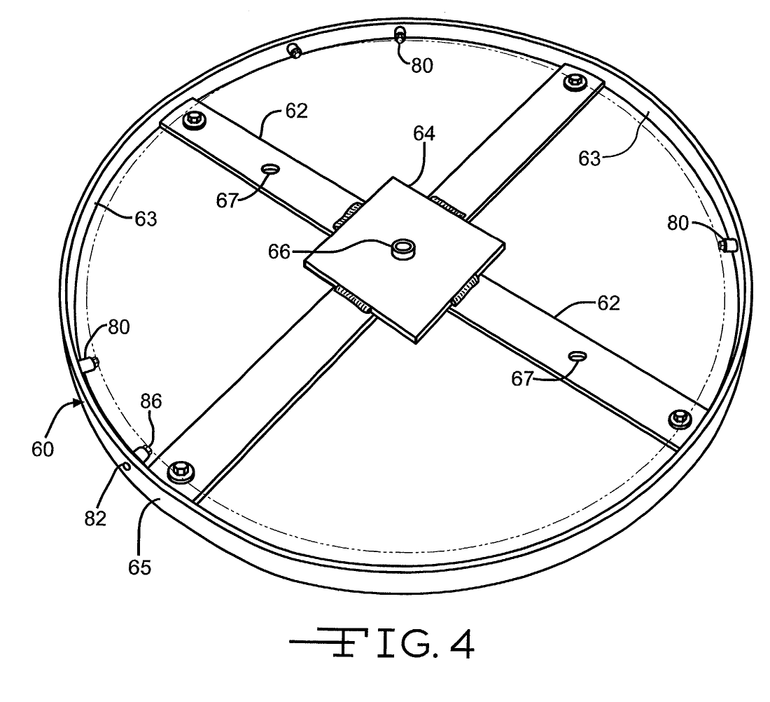

FIG. 5 is a schematic side elevation view of a section of a carousel device.

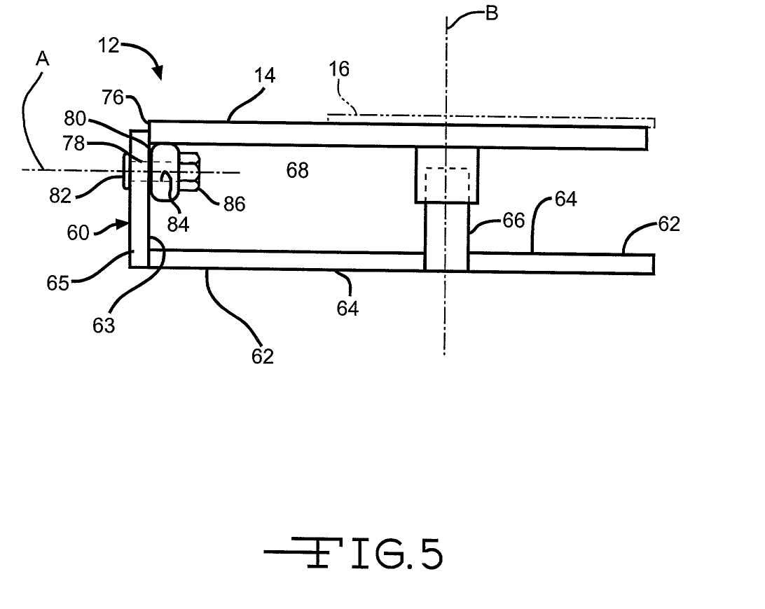

### DETAILED DESCRIPTION OF THE PREFERRED EMBODIMENT

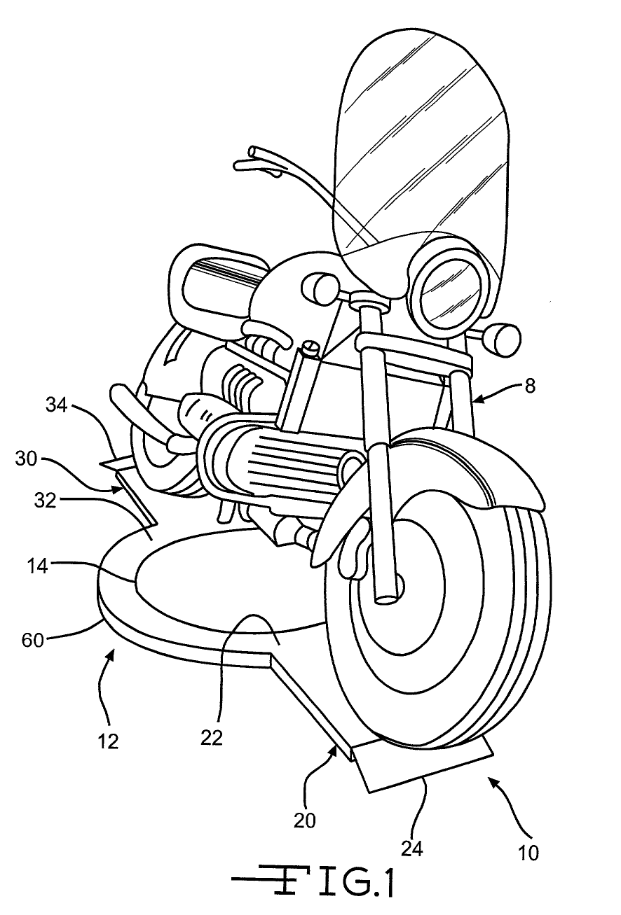

FIG. 1 shows a perspective view of a carousel or turntable device 10 for turning a motorcycle 8 or other heavy object. The carousel device 10 includes a carousel 12 and a base member 60. The carousel device 10 is preferably form of a rigid durable material such as steel webbing or other suitable materials.

The carousel device 10 further includes a pair of opposed wings 20 and 30 which are operatively mounted to and extend in opposing directions from the carousel 12. The first wing 20 has a first end 22 which is operatively mounted to the carousel 12 and an opposing second end 24.

The second wing 30 also defines a first end 32 and a second end 34. It should be understood that the first wing 20 and second wing 30 can have identical features. For ease of illustration, only one wing 20 will be described in detail.

The carousel 12 can have a plurality of openings 18 which receive a suitable securing device such as a bolt or the like, not shown, for securing the wing 20 onto the carousel 12. The wing 20 has an opposing end 24 which is opposed relationship to the first end 22 and the carousel 12.

The second end 24 can have at least one angled surface 28 which has a leading edge or distal end 29. The angled surface 28 of the second end 24 angles in a downward direction from a horizontal plane defined by a top surface 40 of the wing 20. In certain embodiments, the angled surface 28 can be bent at a 45° with respect to the planar surface 40.

In certain aspects of the invention, the wing 20 can further define opposing flange sections 42 which also extend in a depending manner, in a direction from the plane defined by the top surface 40. Also, in certain embodiments, the flanges 42 can be bent or positioned at approximately 90° with respect to the surface 40.

At least one bearing support 50 is shown operatively connected to a lower surface 44 of the planar section 40 of the wing 20. A bearing 52 is operatively mounted in the bearing support 50. The bearing 50 provides support to the wing and allows for smooth rolling of the wing 20 in an arcuate path about a center of the carousel 12. There is no swivel action or other potentially “jamming” or stoppage of the carousel 12 with the use of the smoothly contacting bearing 52. In certain embodiments, the bearing support 50 can be positioned at an acute angle with respect to a longitudinally extending edge 46 of the wing 20. In the embodiment shown, the bearing support 50 has a first end 54 which is in a spaced apart relationship to the first end 22 of the wing 20. The first end 54 is preferably positioned at a first distance D₁ from the edge 46. In the embodiment shown, the first end 54 of the bearing support 50 is preferably positioned at about 1½ inches from the edge 46.

The bearing support 50 defines a second end 56 which is in a spaced apart relationship to the second end 24 of the wing 20. In the embodiment shown, the second end 56 is positioned at a second distance D₂ from the edge 46. In the embodiment shown, the end 56 is preferably positioned at approximately 1 inch from the edge 46. The bearing support 50 and the bearing 52 held therein are positioned at an angle with respect to the edge 46 to allow for easy rotation of the bearing 50 and rolling of the wing 20 as the wing 20 pivots about a center point defined by the carousel 12. In the embodiment shown, the wing 20 has a second bearing support 50′ which holds a second bearing 52′ which has similar features to the bearing support 50 and bearing 52 described above. It should be understood that the opposing bearing supports 50 and 50′ are positioned at acute angles with respect to each other to allow for easy rotation of the wings 20 and 30 about a pivot point defined by the carousel 12.

The base 60 of the carousel device 10 generally includes at least one support member 62 operatively connected to a vertically extending skirt or bearing support member 61. In the embodiment shown, the base 60 has a generally circular shape. Also, in the embodiment shown, the base 60 has a plurality of opposing support members 62 which can be positioned at right angles to each other, generally as shown. In certain embodiments, the carousel device 10 can be secured or fixedly attached to a surface, such as a garage floor, by lagging, or securing the carousel using a suitable bolt or other means (not shown) through one or more openings 67 in the bearing support member(s) 61.

The base 60 further includes a central support member 64 which defines a center pivot point 66 for the carousel 12. In certain embodiments, the center pivot point 66 such as a shaft or other suitable member is connected to the central support section 64. In a preferred embodiment, the central support member 64 can be a suitable material to which the center point pivot 66 is mounted.

A plurality of roller bearings 80 are operatively mounted to the bearing support member 61. In the embodiment shown, the bearings 80 are mounted on an inside surface 63 of the bearing support member 61. It should be understood however, that alternative embodiments of the present invention are contemplated and that the bearings 80 could be mounted on an outside vertical surface 65 of the bearing support member 61. In certain embodiments, about 12 to about 20, and preferably about 16, roller bearings 80 are evenly spaced around the circumference of the bearing support member 61.

The roller bearing 80 is operatively mounted to the bearing support member 61 using an axially extending pin member such as, for example, button-head bolt 82. The pin member 82 extends axially through an opening 78 in the bearing support member 61 and through an opening 84 in the bearing 80. The pin 82 is secured to the bearing support member 61 by a suitable securing means such as a nut 86. The bearing 80 freely rotates about a longitudinal axis A extending through the pin 82.

The carousel 12 includes a table section 14 and in certain embodiments, a decorative plate 16. In certain embodiments, the table section 14 is a steel plate of that has a suitable thickness to support a heavy object; for example, approximately ⅜ inches in thickness.

A mating center pivot point 70 depends from a central portion of a lower surface 68 of the table section 14. The mating center point 70 is preferably a tubular structure which is positioned at a right angle with respect to the table section 14. The center pivot point 66 on the base 60 is axially positioned within the mating center point member 70 such that the table section 14 can pivotally rotate about a vertically extending axis B defined by center points 66 and 70. As the table section 14 is rotated about the axis B, a circumferentially extending edge section of the lower surface 68 of the table section 14 rolls over the bearings 80.

In use, the motorcycle is first rolled across the leading edge 29, up onto the angled surface 28, across the top surface 40 of the first wing 20, onto the carousel 12 and at least partially across the table section 14, and, finally, at least partially onto the second wing 30. In order to turn the motorcycle, the rider pivots the carousel device 10 about the axis B through the center of the carousel 12. As the carousel 12 pivots, the lower surface 68 of the table section 14 rolls over the bearings 80. The wings 20 and 30 also pivot about the axis B and are circumferentially moved in a desired direction. The carousel device 10 can be pivoted to any position about a 360° path.

While the invention has been described in connection with certain preferred embodiments, it is not intended to limit the scope of the invention to the particular embodiments as set forth above, but is rather intended to cover such alternative embodiments and equivalences may be included within the spirit and scope of the invention as defined by the appended claims.

I claim:

1. A carousel device for pivotally moving an object comprising
a base having a plurality of roller bearings mounted thereon, and
a carousel having a pair of opposing wings, each wing having a first end operatively connected to the carousel, a second end in opposed relationship to the first end, and at least one bearing operatively connected to each wing.

2. The device of claim 1, wherein the second end by each wing has at least one angled surface which depends in a downward direction from a horizontal plane defined by a top surface of the wing.

3. The device of claim 1, wherein each wing further comprises at least two bearings operatively connected to a lower surface of the wing.

4. The device of claim 3, wherein each wing includes at least one bearing support for securing the bearing to the wing, the bearing support being mounted on the lower surface of the wing, each bearing support being positioned at an acute angle with respect to a longitudinally extending edge of the wing.

5. The device of claim 4, wherein each bearing support defines a first end which is a first spaced apart relationship to a longitudinally edge extending of the wing at a first distance and wherein the bearing support defines a second end which is in a second spaced apart relationship to the longitudinally extending edge at a second distance whereby the bearing support is positioned at the acute angle with respect to the longitudinally extending edge of the wing.

6. The device of claim 1, wherein the base comprises at least one vertically extending bearing support member having a generally circular shape and at least one cross support member extending in a radial direction therefrom, the base further including a central support member operatively connected to the cross support member which central support member defines a center pivot point.

7. The device of claim 6, wherein a plurality of roller bearings are operatively mounted to the bearing support member.

8. The device of claim 7, wherein the bearings are mounted on an inside surface of the bearing support member.

9. The device of claim 7, wherein the bearings are mounted on an outside surface of the bearing support member.

10. The device of claim 1, wherein a top surface of each wing is spaced from about 1½ inches to about 2 inches from a ground surface.
